(19) United States
(12) Patent Application Publication
(10) Pub. No.: US 2010/0271326 A1
(43) Pub. Date: Oct. 28, 2010

(54) METHOD FOR OPERATING ELECTRONIC DEVICE USING TOUCH PAD

(75) Inventors: Che-Hsien Hu, Taipei City (TW); Yi-Hung Shen, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: COMPAL ELECTRONICS, INC., Taipei City (TW)

(21) Appl. No.: 12/722,544

(22) Filed: Mar. 12, 2010

Related U.S. Application Data
(60) Provisional application No. 61/172,791, filed on Apr. 27, 2009.

(51) Int. Cl. G06F 3/045

(52) U.S. Cl. 345/174

(57) ABSTRACT

A method for operating an electronic device by using a touch pad is provided. In the present method, a plurality of conductive balls within the touch pad is used for detecting a pressure value received by the touch pad when the touch pad is pressed. Then, whether a variation of the pressure value exceeds an operating criterion twice in succession during an operating period is determined. A double-click operation is executed in the electronic device if the pressure value exceeds the operating criterion twice in succession during the operating period. As a result, a number of operation modes supported by the touch pad is increased, so as to facilitate the using of the touch pad.

### CROSS-REFERENCE TO RELATED APPLICATION

This application claims the priority benefit of U.S. provisional application Ser. No. 61/172,791, filed on Apr. 27, 2009. The entirety of the above-mentioned patent application is hereby incorporated by reference herein and made a part of specification.

### BACKGROUND OF THE INVENTION

1. Field of the Invention

The present invention relates to a method for operating an electronic device. More particularly, the present invention relates to a method for operating an electronic device by using a touch pad.

2. Description of Related Art

With development of touch technology, touch panels gradually become main input devices for electronic devices. The touch panels can be grouped into resistive touch panels, capacitive touch panels, optical touch panels and electromagnetic touch panels etc. according to different internal structures and sensing methods. Wherein, the resistive touch panel and the capacitive touch panel are most popular in the market.

Since the resistive touch panel has an advantage of low price, and allows a user to perform operations through touch media such as a finger or a stylus, etc., it is widely applied in various consumable electronic products. The capacitive touch panel ameliorates a defect of the resistive touch panel that the resistive touch panel is easy to be scratched to cause a malfunction, though a fabrication process thereof is not easy, and a price thereof is expensive, so that the capacitive touch panel is generally used in high-price electronic products.

Regarding an operation method, the resistive touch panel is formed by stacking two conductive layers, and a plurality of DOT spacers are disposed between the conductive layers. A touch operation of the user can conduct a loop, so that a controller in internal of the resistive touch panel can deduce a touch coordinates according to a ratio of voltage drops. In case of the capacitive touch panel, an electric field is formed on a surface of the touch panel, and an internal controller thereof can deduce the touch coordinates according to a current variation when a conductive object touches the surface of the touch panel to cause the current variation. Generally, regardless of the resistive touch panel or the capacitive touch panel, the touch coordinates are obtained to control the electronic device to respond the touch operation of the user.

### SUMMARY OF THE INVENTION

The present invention is directed to a method for operating an electronic device through a touch pad, by which a user can perform a double-click operation on the electronic device through the touch pad containing a plurality of conductive balls.

The present invention provides a method for operating an electronic device by using a touch pad, and the touch pad contains a plurality of conductive balls. In the method, a pressure value received by the conductive balls is detected when the touch pad is pressed. Whether a variation of the pressure value detected by the conductive balls exceeds an operating criterion twice in succession during an operating period is determined, and a double-click operation is executed in the electronic device if the variation of the pressure value exceeds the operating criterion twice in succession during the operating period.

In an embodiment of the present invention, the step of detecting the pressure value when the touch pad is pressed includes obtaining a current amount generated in response to deformation of at least one of the conductive balls when the touch pad is pressed, and calculating the pressure value according to the current amount.

In an embodiment of the present invention, the method for operating the electronic device by using the touch pad further includes defining the operating period as a sum of a double of a release time and one press time, and defining the operating criterion as a difference between a pressure threshold and an upper bound of a predetermined pressure range. Wherein, the upper bound of the predetermined pressure range is less than the pressure threshold.

In an embodiment of the present invention, the step of determining whether the variation of the pressure value exceeds the operating criterion twice in succession during the operating period includes following steps. When the pressure value detected by the conductive balls is greater than or equal to the pressure threshold, it is determined whether the pressure value detected by the conductive balls is within the predetermined pressure range before the release time expires. If yes, after the pressure value within the predetermined pressure range is detected, it is determined that whether the pressure value detected by the conductive balls is greater than or equal to the pressure threshold before the press time expires. If yes, after the pressure value greater than or equal to the pressure threshold is detected, it is determined that whether the pressure value detected by the conductive balls is within the predetermined pressure range during the release time. If yes, the variation of the pressure value is defined as exceeding the operating criterion twice in succession during the operating period.

In an embodiment of the present invention, if the conductive balls do not detect the pressure value within the predetermined pressure range before the release time expires, a selection operation is executed in the electronic device.

In an embodiment of the present invention, if the conductive balls do not detect the pressure value greater than or equal to the pressure threshold before the press time expires, a selection operation is executed in the electronic device.

In an embodiment of the present invention, the method for operating the electronic device by using the touch pad further includes obtaining the conductive balls deformed by pressing of the touch pad from all of the conductive balls, and calculating coordinates corresponding to the pressure value according to a position of each of the conductive balls which are deformed in the touch pad. The step of determining whether the variation of the pressure value exceeds the operating criterion twice in succession during the operating period includes defining the variation of the pressure value detected by the conductive balls does not exceed the operating criterion twice in succession during the operating period if a displacement of the coordinates exceeds an error range.

In an embodiment of the present invention, the method for operating the electronic device by using the touch pad further includes following steps. Each time when the touch pad is pressed and the pressure value is varied, the conductive balls deformed by pressing of the touch pad are obtained from all of the conductive balls, and a pressing direction acting on the touch pad is calculated according to positions of the conductive balls which are deformed relative to the conductive balls which are not deformed in the touch pad. Then, a previous pressing direction acting on the touch pad before the pressure value is varied is obtained, and a cursor displayed by the electronic device is moved towards the pressing direction when the pressing direction is different to the previous pressing direction.

In an embodiment of the present invention, the method for operating the electronic device by using the touch pad further includes adjusting a moving speed of the cursor displayed by the electronic device that moves towards the pressing direction according to the variation of the pressure value detected by the conductive balls when the pressing direction is the same to the previous pressing direction.

The present invention provides a method for operating an electronic device by using a touch pad, and the touch pad comprises a plurality of conductive balls. In the method, a pressure value received by the conductive balls is detected when the touch pad is pressed. Then, each time when the pressure value is varied, a pressing direction acting on the touch pad is calculated, and a previous pressing direction acting on the touch pad before the pressure value is varied is obtained. When the pressing direction is the same to the previous pressing direction, a moving speed of a cursor displayed by the electronic device that moves towards the pressing direction is adjusted according to a variation of the pressure value.

In an embodiment of the present invention, after the step of obtaining the previous pressing direction, the method further includes moving the cursor displayed by the electronic device towards the pressing direction when the pressing direction is different to the previous pressing direction.

In an embodiment of the present invention, the step of calculating the pressing direction received by the touch pad includes obtaining the conductive balls deformed by pressing of the touch pad from all of the conductive balls, and calculating the pressing direction according to positions of the conductive balls which are deformed relative to the conductive balls which are not deformed in the touch pad.

According to the above descriptions, in the present invention, whether the double-click operation is executed in the electronic device is determined according to whether the variation of the pressure value received by touch pad exceeds an operating criterion twice in succession during the operating period. As a result, a number of operation modes supported by the touch pad is increased, so as to improve a convenience of using the touch pad to operate the electronic device.

In order to make the aforementioned and other features and advantages of the present invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating a touch operation system according to an embodiment of the present invention.

FIG. 2 is a curve diagram of pressure values and time according to an embodiment of the present invention.

FIG. 3 is a flowchart illustrating a method for operating an electronic device by using a touch pad according to an embodiment of the present invention.

FIG. 4 is a curve diagram of pressure values received by a touch pad and time when a user performs operations to the touch pad according to an embodiment of the present invention.

FIG. 5 is a flowchart illustrating a method for operating the electronic device by using the touch pad according to another embodiment of the present invention.

### DESCRIPTION OF THE EMBODIMENTS

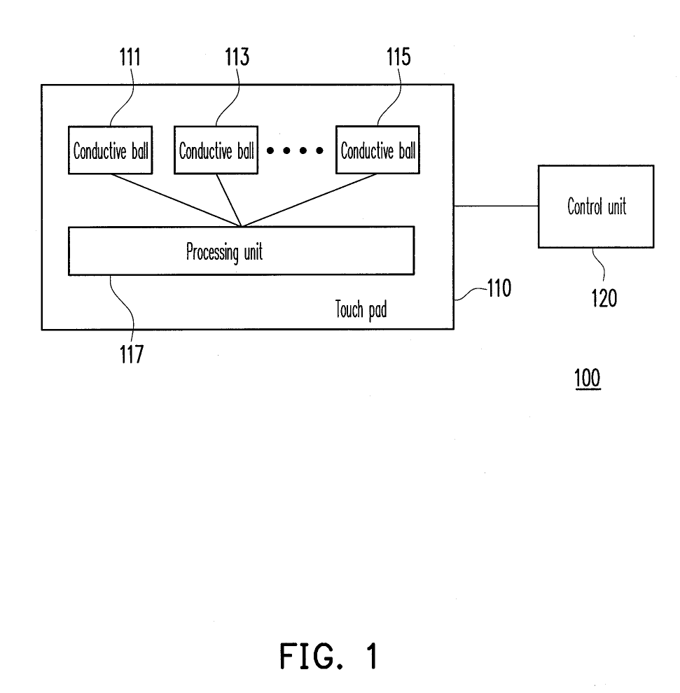

FIG. 1 is a block diagram illustrating a touch operation system according to an embodiment of the present invention. Referring to FIG. 1, the touch operation system 100 includes a touch pad 110 and a control unit 120. The touch operation system 100 is used for recognizing a touch operation of a user performed on the touch pad 110, so as to control an electronic device to respond the touch operation of the user. Wherein, the electronic device is, for example, a computer system or a consumable electronic product, etc., which is not limited by the present invention.

In the present embodiment, a plurality of conductive balls (for example, conductive balls 111-115) is disposed underneath a surface of the touch pad 110. The conductive balls can be used to obtain a pressure value received by the touch pad 110 when the touch pad 110 is pressed. It should be noticed that a shape of the touch pad 110 is not limited by the present invention, and an amount and a distribution of the conductive balls are also not limited.

A processing unit 117 is coupled to all of the conductive balls. When the user presses the touch pad 110 to deform the conductive balls, the processing unit 117 can calculate the pressure value received by the touch pad 110 according to a deformation state of the conductive balls.

The control unit 120 is, for example, an embedded controller (EC) configured in the electronic device. The control unit 120 can be connected to the touch pad 110 through a serial peripheral interface (SPI), a system management bus (SM bus), a personal system/2 (PS/2) interface, or a universal asynchronous receiver-transmitter (UART) interface. The control unit 120 obtains the pressure value received by the touch pad 110, and determines whether or not to trigger the electronic device to execute a corresponding operation.

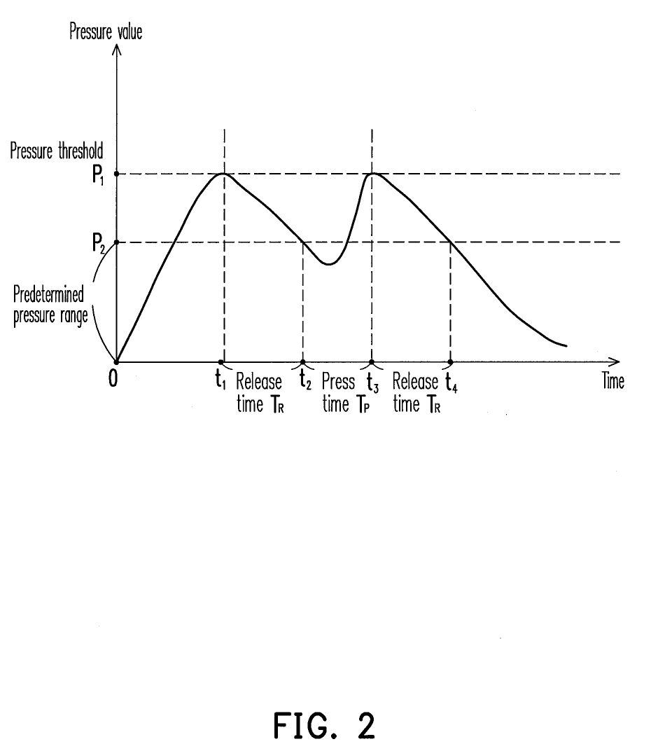

In detail, the touch operation system 100 determines an action of the user according to a time of the touch pad 110 being pressed and a variation of the pressure value received by the touch pad 110. Accordingly, the touch operation system 100 defines two parameters of a pressure threshold and a predetermined pressure range for distinguishing a magnitude of the pressure value received by the touch pad 110, and defines two parameters of a release time and a press time for determining the time during which the touch pad 110 is pressed. The release time indicates a time during which the user has to decrease the pressure applied to the touch pad 110, and the press time indicates a time during which the user has to increase the pressure applied to the touch pad 110. Referring to FIG. 2, FIG. 2 is a curve diagram of pressure values and time according to an embodiment of the present invention. Wherein, an upper bound P2 of the predetermined pressure range is less than the pressure threshold P1, and a lower bound of the predetermined pressure range is 0. In an embodiment, the control unit 120 defines the operation period as a sum of a double of the release time and one press time (i.e. t4−t1), and defines an operating criterion as a difference between the pressure threshold P1 and the upper bound P2 of the predetermined pressure range (i.e. P1-P2). The control unit 120 can determine whether the variation of the pressure value exceeds the operating criterion twice in succession during the operating period according to the above parameters, so as to determine whether or not to trigger the electronic device to execute a double-click operation. Execution of the double-click operation in the electronic device may lead to a result identical to that cause by pressing a computer mouse button twice quickly.

In other words, assuming T_{R} represents the release time and T_{P} represents the press time, if a pressure value greater than or equal to the pressure threshold is detected at a time point t₁ for the first time, a pressure value within the predetermined pressure range has to be detected at or before a time point (t₁+T_{R}), a pressure value greater than or equal to the pressure threshold has to be again detected at or before a time point (t₁+T_{R}+T_{P}), and a pressure value within the predetermined pressure range has to be detected at or before a time point (t₁+2×T_{R}+T_{P}), and then the control unit 120 triggers the electronic device to execute the double-click operation.

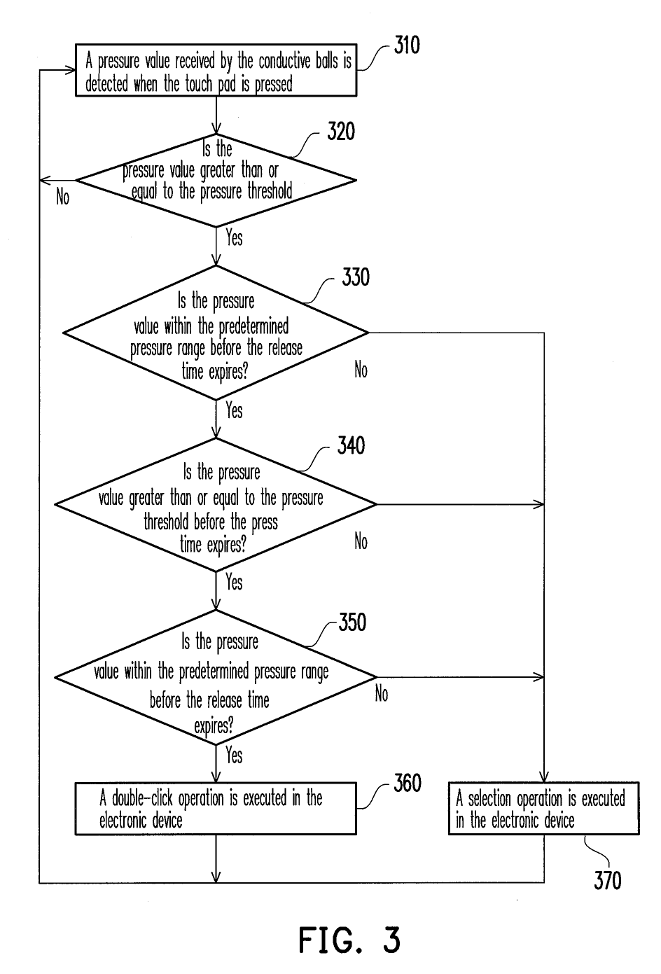

An operation method of the touch operation system 100 is described in detail with reference of a following flowchart. FIG. 3 is a flowchart illustrating a method for operating an electronic device by using a touch pad according to an embodiment of the present invention. In the present embodiment, a detailed flow that the touch operation system 100 controls the electronic device to execute the double-click operation is described.

First, in step 310, a pressure value received by the conductive balls within the touch pad 110 is detected when the touch pad 110 is pressed. In detail, each time when the user touches or presses the touch pad 110, one or a plurality of the conductive balls in the touch pad 110 is deformed because of the touch pad 110 is pressed. Once the conductive balls are deformed, a resistance there between is relatively changed, so that a current amount is influenced. Therefore, as long as the processing unit 117 obtains the current amount generated in response to the deformation of the conductive balls, the processing unit 117 can calculate the pressure value according to the current amount. In the present embodiment, the processing unit 117 can individually calculate a partial pressure value relevant to each of the conductive balls, so as to deduce the pressure value received by the whole touch pad 110.

In the present embodiment, whether the control unit 120 controls the electronic device to execute the double-click operation is determine according to whether the variation of the pressure value received by the touch pad 110 exceeds the operating criterion twice in succession during the operating period after the user actually presses the touch pad 110. Therefore, in a following step 320, the control unit 120 first determines whether the pressure value detected by the conductive balls is greater than or equal to the pressure threshold, so as to determine whether the user actually presses the touch pad 110. In other words, if the user exerts a too small strength to touch the touch pad 110, the pressure value is lower than the pressure threshold, and the touch operation system 100 does not control the electronic device to respond the user's touch operation.

Since the conductive balls in the touch pad 110 can be continually deformed in response to the touch operation of the user performed on the touch pad 110, the processing unit 117 can correspondingly calculate the pressure values, and transmit the pressure values to the control unit 120. Therefore, the steps 310 and 320 in the flowchart of FIG. 3 are repeatedly executed until the pressure value detected by the conductive balls is greater than or equal to the pressure threshold, and then the control unit 120 determines that the user actually presses the touch pad 110.

Next, in step 330, the control unit 120 determines whether the pressure value detected by the conductive balls is within the predetermined pressure range before the release time expires.

If the pressure value detected by the conductive balls is not within the predetermined pressure range before the release time expires, in step 370, the control unit 120 triggers the electronic device to execute a selection operation.

If the pressure value detected by the conductive balls is within the predetermined pressure range before the release time expires, it represents that the pressure applied to the touch pad 110 by the user is decreased. Namely, the user probably withdraws his/her finger from the touch pad 110, or exerts a smaller strength on the touch pad 110. Therefore, in step 340, after the control unit 120 determines that the conductive balls detect the pressure value within the predetermined pressure range, the control unit 120 continually determines whether the pressure value detected by the conductive balls is greater than or equal to the pressure threshold before the press time expires.

If the pressure value detected by the conductive balls is not greater than or equal to the pressure threshold within the press time, the step 370 is executed, by which the control unit 120 triggers the electronic device to execute the selection operation.

However, if the pressure value detected by the conductive balls is greater than or equal to the pressure threshold within the press time, it represents that the user again presses the touch pad 110 with a larger strength within the press time. Therefore, in step 350, after the control unit 120 determines that the conductive balls detect the pressure value greater than or equal to the pressure threshold, the control unit 120 continually determines whether the pressure value detected by the conductive balls is within the predetermined pressure range before the release time expires.

If the pressure value detected by the conductive balls is not within the predetermined pressure range before the release time expires, the step 370 is executed, by which the control unit 120 triggers the electronic device to execute the selection operation. Conversely, if the pressure value detected by the conductive balls is within the predetermined pressure range before the release time expires, the control unit 120 then defines the variation of the pressure value as exceeding the operating criterion twice in succession during the operating period. Therefore, in step 360, the control unit 120 triggers the electronic device to execute the double-click operation by sending an instruction.

In the present embodiment, when the control unit 120 determines that the user actually presses the touch pad 110, as long as the variation of the pressure value detected by the conductive balls exceeds the operating criterion within the release time, it can be determined that the user performs a single-click operation on the touch pad 110. As long as two single-click operations are determined to be performed successively during the operating period, the control unit 120 can control the electronic device to execute the double-click operation.

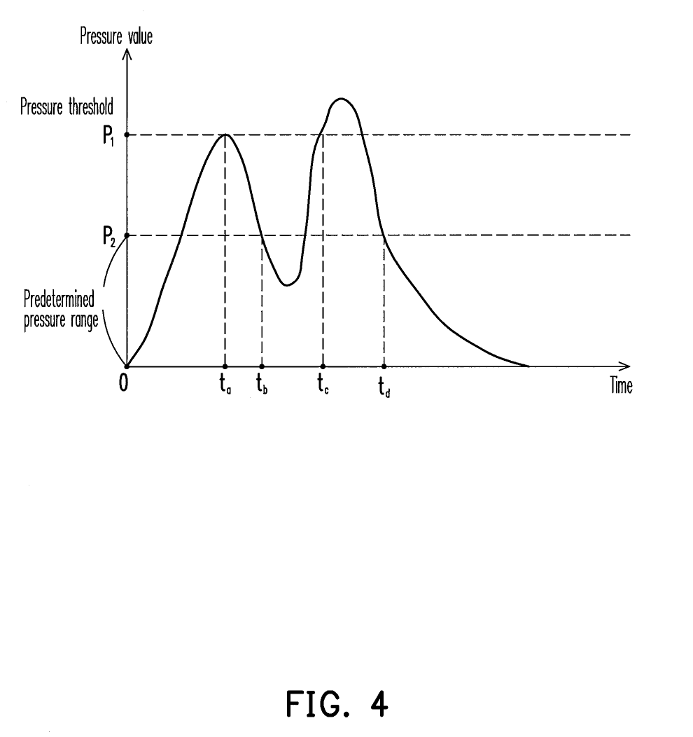

FIG. 4 is a curve diagram of pressure values received by the touch pad 110 and time when the user performs operations to the touch pad 110 according to an embodiment of the present invention. As shown in FIG. 4, the pressure value detected by the conductive balls in the touch pad 110 is equal to the pressure threshold P1 at a time point tₐ, and the pressure value is within the predetermined pressure range at a time point t_{b}. Then, the pressure value is again equal to the pressure threshold P1 at a time point t_{c}, and is within the predetermined pressure range at a time point t_{d}.

If a difference between the time point t_{b} and the time point tₐ does not exceed the release time, a difference between the time point t_{c} and the time point t_{b} does not exceed the press time, and a difference between the time point t_{d} and the time point t_{c} does not exceed the release time (i.e. t_{d}-tₐ does not exceed a sum of a double of the release time and one press time), the control unit 120 determines that the variation of the pressure value received by the touch pad 110 exceeds the operating criterion twice in succession during the operating period.

In an other embodiment, when the conductive balls are deformed due to the touch of the user, the processing unit 117 calculates the magnitude of the pressure value, and further obtains the conductive balls deformed by pressing of the touch pad 110 from all of the conductive balls, and calculates coordinates corresponding to the pressure value according to a position of each of the deformed conductive balls in the touch pad 110. Such coordinates and the pressure value are transmitted to the control unit 120.

Accordingly, if a displacement of the coordinates corresponding to the pressure values exceeds an error range during the operating period, the control unit 120 determines the variation of the pressure value does not exceed the operating criterion twice in succession during the operating period. In other words, only when the coordinates corresponding to each touch operation received by the touch pad 110 is within the error range during the operating period, the control unit 120 can drive the electronic device to execute the double-click operation.

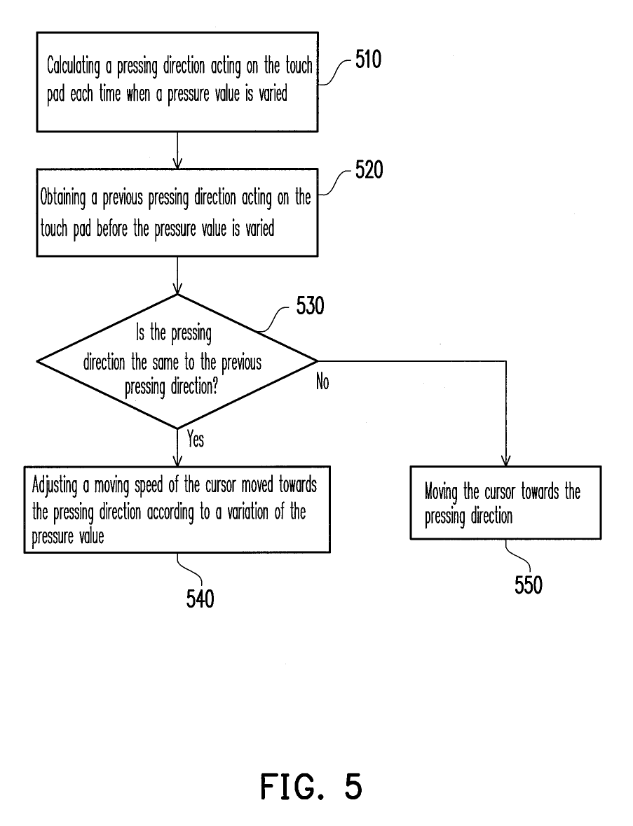

FIG. 5 is a flowchart illustrating a method for operating the electronic device by using the touch pad according to another embodiment of the present invention. In the present embodiment, a detailed flow that the touch operation system 100 moves a cursor displayed by the electronic device is described. Referring to FIG. 5, in step 510, each time when a pressure value detected by the conductive balls is varied, the processing unit 117 obtains the conductive balls deformed by the pressing of the touch pad 110 from all of the conductive balls, and calculates a pressing direction acting on the touch pad 110 according to positions of the conductive balls which are deformed relative to the conductive balls which are not deformed in the touch pad 110. In the present embodiment, the pressing direction corresponding to each pressure value variation is transmitted to the control unit 120.

In step 520, the control unit 120 obtains a previous pressing direction acting on the touch pad 110 before the pressure value is varied, and in step 530, the previous pressing direction is compared with the latest pressing direction to determine whether the pressing direction is the same to the previous pressing direction.

If the pressing direction is different to the previous pressing direction, in step 550, the control unit 120 controls the cursor displayed by the electronic device to move towards the pressing direction. Namely, the cursor originally moved towards the previous pressing direction is now moved towards the latest pressing direction.

However, when the pressing direction is the same to the previous pressing direction, in step 540, the control unit 120 controls the electronic device to adjust a moving speed of the displayed cursor moved towards the pressing direction according to the variation of the pressure value. For example, if the pressure value is increased, the control unit 120 controls the electronic device to increase the moving speed of the cursor moved towards the pressing direction. However, if the pressure value is decreased, the control unit 120 controls the electronic device to decrease the moving speed of the cursor moved towards the pressing direction. Regardless of increasing or decreasing the moving speed of the cursor, a moving direction of the cursor is maintained unchanged.

As shown in FIG. 5, as long as the user changes a center of the pressure applied to the touch pad 110 to change the pressing direction, a moving direction of the cursor is adjusted. In case that the pressing direction is maintained unchanged, the user can control the moving speed of the cursor by increasing or decreasing a press strength.

In summary, according to the method for operating the electronic device by using the touch pad of the present invention, whether the double-click operation is executed in the electronic device is determined according to the variation of the pressure value during the operating period, and the moving speed of the cursor displayed by the electronic device is adjusted according to the variation of the pressure value. As a result, a number of operation modes supported by the touch pad containing the conductive balls is increased, so that the user can perform the mouse double click, move the cursor, and change the moving speed of the cursor on the touch pad without withdrawing the finger, and accordingly a convenience of using the touch pad to operate the electronic device is improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for operating an electronic device by using a touch pad comprising a plurality of conductive balls, and the method comprising:
detecting a pressure value received by the conductive balls when the touch pad is pressed;
determining whether a variation of the pressure value detected by the conductive balls exceeds an operating criterion twice in succession during an operating period; and
if yes, executing a double-click operation in the electronic device.

2. The method for operating the electronic device by using the touch pad as claimed in claim 1, wherein the detecting step comprises:
obtaining a current amount generated in response to deformation of at least one of the conductive balls when the touch pad is pressed; and
calculating the pressure value according to the current amount.

3. The method for operating the electronic device by using the touch pad as claimed in claim 1, further comprising:
defining the operating period as a sum of a double of a release time and one press time; and
defining the operating criterion as a difference between a pressure threshold and an upper bound of a predetermined pressure range, wherein the upper bound of the predetermined pressure range is less than the pressure threshold.

4. The method for operating the electronic device by using the touch pad as claimed in claim 3, wherein the step of determining whether the variation of the pressure value exceeds the operating criterion twice in succession during the operating period comprises:
when the pressure value detected by the conductive balls is greater than or equal to the pressure threshold, determining whether the pressure value detected the conductive balls is within the predetermined pressure range before the release time expires;
if yes, determining whether the pressure value detected by the conductive balls is greater than or equal to the pressure threshold before the press time expires after the pressure value within the predetermined pressure range is detected;
if yes, determining whether the pressure value detected by the conductive balls is within the predetermined pressure range before the release time expires after the pressure value greater than or equal to the pressure threshold is detected; and
if yes, defining that the variation exceeds the operating criterion twice in succession during the operating period.

5. The method for operating the electronic device by using the touch pad as claimed in claim 4, wherein after the step of determining whether the pressure value detected by the conductive balls is within the predetermined pressure range before the release time expires, the method further comprises:
if no, executing a selection operation in the electronic device.

6. The method for operating the electronic device by using the touch pad as claimed in claim 4, wherein after the step of determining whether the pressure value detected by the conductive balls is greater than or equal to the pressure threshold before the press time expires, the method further comprises:
if no, executing a selection operation in the electronic device.

7. The method for operating the electronic device by using the touch pad as claimed in claim 1, further comprising:
obtaining the conductive balls deformed by pressing of the touch pad from all of the conductive balls; and
calculating coordinates corresponding to the pressure value according to a position of each of the conductive balls which are deformed in the touch pad.

8. The method for operating the electronic device by using the touch pad as claimed in claim 7, wherein the step of determining whether the variation of the pressure value exceeds the operating criterion twice in succession during the operating period further comprises:
defining the variation of the pressure value does not exceed the operating criterion twice in succession during the operating period if a displacement of the coordinates exceeds an error range.

9. The method for operating the electronic device by using the touch pad as claimed in claim 1, further comprising:
obtaining the conductive balls deformed by pressing of the touch pad from all of the conductive balls each time when the touch pad is pressed and the pressure value is varied, and calculating a pressing direction acting on the touch pad according to positions of the conductive balls which are deformed relative to the conductive balls which are not deformed in the touch pad;
obtaining a previous pressing direction acting on the touch pad before the pressure value is varied; and
moving a cursor displayed by the electronic device towards the pressing direction when the pressing direction is different to the previous pressing direction.

10. The method for operating the electronic device by using the touch pad as claimed in claim 9, further comprising:
adjusting a moving speed of the cursor displayed by the electronic device that moves towards the pressing direction according to the variation of the pressure value when the pressing direction is the same to the previous pressing direction.

11. A method for operating an electronic device by using a touch pad comprising a plurality of conductive balls, and the method comprising:
detecting a pressure value received by the conductive balls when the touch pad is pressed;
calculating a pressing direction acting on the touch pad each time when the pressure value is varied;
obtaining a previous pressing direction acting on the touch pad before the pressure value is varied; and
adjusting a moving speed of a cursor displayed by the electronic device that moves towards the pressing direction according to a variation of the pressure value when the pressing direction is the same to the previous pressing direction.

12. The method for operating the electronic device by using the touch pad as claimed in claim 11, wherein after the obtaining step, the method further comprises:
moving the cursor displayed by the electronic device towards the pressing direction when the pressing direction is different to the previous pressing direction.

13. The method for operating the electronic device by using the touch pad as claimed in claim 11, wherein the calculating step comprises:
obtaining the conductive balls deformed by pressing of the touch pad from all of the conductive balls; and
calculating the pressing direction according to positions of the conductive balls which are deformed relative to the conductive balls which are not deformed in the touch pad.
